(19) United States
(12) Patent Application Publication
(10) Pub. No.: US 2025/0193836 A1
(43) Pub. Date: Jun. 12, 2025

(54) POSITIONING MESSAGE TRANSMISSION METHOD, TERMINAL, AND NETWORK SIDE DEVICE

(71) Applicant: VIVO MOBILE COMMUNICATION CO., LTD., Dongguan (CN)

(72) Inventors: Yuan LI, Dongguan (CN); Hongping ZHANG, Dongguan (CN); Xiang PAN, Dongguan (CN)

(21) Appl. No.: 19/053,545

(22) Filed: Feb. 14, 2025

Related U.S. Application Data
(63) Continuation of application No. PCT/CN2023/112203, filed on Aug. 10, 2023.

(30) Foreign Application Priority Data
Aug. 15, 2022 (CN) 202210981662.6

(51) Int. Cl. H04W 64/00; H04W 48/16; H04W 92/18

(52) U.S. Cl. CPC H04W 64/00; H04W 48/16; H04W 92/18

(57) ABSTRACT

A positioning message transmission method includes at least one of the following: generating, by a first protocol layer of a network side device, a first positioning message, the first positioning message being used for sidelink (SL) positioning; and sending, by the first protocol layer of the network side device, the first positioning message; or receiving, by the first protocol layer of the network side device, the first positioning message.

### CROSS-REFERENCE RELATED APPLICATIONS

This application is a bypass continuation of International Application No. PCT/CN2023/112203, filed on Aug. 10, 2023, which claims the benefit of and priority to Chinese Patent Application No. 202210981662.6, filed on Aug. 15, 2022 and entitled “POSITIONING MESSAGE TRANSMISSION METHOD, TERMINAL, AND NETWORK SIDE DEVICE,” the contents of both of which being incorporated by reference in their entireties herein.

### TECHNICAL FIELD

This application pertains to the field of communication technologies, and specifically relates to a positioning message transmission method, a terminal, and a network side device.

### BACKGROUND

Long Term Evolution Positioning Protocol (LTE Positioning Protocol, LPP) is a protocol applicable between a positioning server and a positioning target. In a control plane, the LPP protocol may be used for positioning information exchange between a network side device serving as a positioning server and a terminal. For example, the LPP protocol may be used for positioning information exchange between a Location Management Function (LMF) on a core network side and a terminal.

Currently, the LPP may support a network side device serving as a positioning server in controlling a terminal over an air interface to perform positioning in the air interface. However, in a scenario of sidelink (SL), which may also be referred to as a secondary link, a side link, a direct link, or the like) positioning, the network side device serving as the positioning server still cannot control the terminal over the air interface to perform SL positioning.

### BRIEF SUMMARY

Embodiments of this application provide a positioning message transmission method, a terminal, and a network side device, to resolve a problem that currently a network side device serving as a positioning server cannot control a terminal over an air interface to perform SL positioning.

According to a first aspect, a positioning message transmission method is provided. The method includes at least one of the following: generating, by a first protocol layer of a network side device, a first positioning message, where the first positioning message is used for SL positioning; and sending, by the first protocol layer of the network side device, the first positioning message; or receiving, by the first protocol layer of the network side device, the first positioning message.

According to a second aspect, a positioning message transmission apparatus is provided. The apparatus includes at least one of the following: a generation module, configured to generate a first positioning message, where the first positioning message is used for SL positioning; a sending module, configured to send the first positioning message; and a receiving module, configured to receive the first positioning message.

According to a third aspect, a positioning message transmission method is provided. The method includes at least one of the following: receiving, by a first protocol layer of a terminal, a first positioning message, where the first positioning message is used for SL positioning; or generating, by the first protocol layer of the terminal, the first positioning message; and sending, by the first protocol layer of the terminal, the first positioning message.

According to a fourth aspect, a positioning message transmission apparatus is provided. The apparatus includes at least one of the following: a receiving module, configured to receive a first positioning message, where the first positioning message is used for SL positioning; a generation module, configured to generate the first positioning message; and a sending module, configured to send the first positioning message.

According to a fifth aspect, a network side device is provided. The network side device includes a processor and a memory. The memory stores a program or instructions that are capable of running on the processor, and the program or the instructions are executed by the processor to implement the steps of the method according to the first aspect.

According to a sixth aspect, a network side device is provided, including a processor and a communication interface. The processor is configured to generate a first positioning message, where the first positioning message is used for SL positioning. The communication interface is configured to send the first positioning message, or the communication interface is configured to receive the first positioning message.

According to a seventh aspect, a terminal is provided. The terminal includes a processor and a memory. The memory stores a program or instructions that are capable of running on the processor, and the program or the instructions are executed by the processor to implement the steps of the method according to the third aspect.

According to an eighth aspect, a terminal is provided, including a processor and a communication interface. The communication interface is configured to receive a first positioning message, where the first positioning message is used for SL positioning. Alternatively, the processor is configured to generate the first positioning message, and the communication interface is configured to send the first positioning message.

According to a ninth aspect, a positioning message transmission system is provided, including a terminal and a network side device. The terminal may be configured to perform the steps of the positioning message transmission method according to the third aspect, and the network side device may be configured to perform the steps of the positioning message transmission method according to the first aspect.

According to a tenth aspect, a readable storage medium is provided. The readable storage medium stores a program or instructions, and the program or the instructions are executed by a processor to implement the steps of the method according to the first aspect, or implement the steps of the method according to the third aspect.

According to an eleventh aspect, a chip is provided. The chip includes a processor and a communication interface, and the communication interface is coupled to the processor. The processor is configured to run a program or instructions to implement the method according to the first aspect, or implement the method according to the third aspect.

According to a twelfth aspect, a computer program/program product is provided. The computer program/program product is stored in a storage medium, and the computer program/program product is executed by at least one processor to implement the steps of the positioning message transmission method according to the first aspect, or implement the steps of the positioning message transmission method according to the third aspect.

### BRIEF DESCRIPTION OF DRAWINGS

FIG. 1 is a schematic diagram of a wireless communication system according to an embodiment of this application;

FIG. 2 is a schematic flowchart of a positioning message transmission method according to an embodiment of this application;

FIG. 3 is a schematic flowchart of a positioning message transmission method according to an embodiment of this application;

FIG. 4 is a schematic flowchart of a positioning message transmission method according to an embodiment of this application;

FIG. 5 is a schematic flowchart of a positioning message transmission method according to an embodiment of this application;

FIG. 6 is a schematic diagram of a protocol stack for transmitting an SL positioning message according to an embodiment of this application;

FIG. 7 is a schematic flowchart of a positioning message transmission method according to an embodiment of this application;

FIG. 8 is a schematic diagram of a protocol stack for transmitting an SL positioning message according to an embodiment of this application;

FIG. 9 is a schematic flowchart of a positioning message transmission method according to an embodiment of this application;

FIG. 10 is a schematic diagram of a structure of a positioning message transmission apparatus according to an embodiment of this application;

FIG. 11 is a schematic diagram of a structure of a positioning message transmission apparatus according to an embodiment of this application;

FIG. 12 is a schematic diagram of a structure of a communication device according to an embodiment of this application;

FIG. 13 is a schematic diagram of a structure of a terminal according to an embodiment of this application; and

FIG. 14 is a schematic diagram of a structure of a network side device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some rather than all of the embodiments of this application. All other embodiments obtained by a person of ordinary skill in the art based on the embodiments of this application shall fall within the protection scope of this application.

In the specification and claims of this application, the terms “first”, “second”, and the like are intended to distinguish between similar objects but do not intended to describe a specific order or sequence. It should be understood that terms used in this way are interchangeable in appropriate cases, so that the embodiments of this application can be implemented in an order other than those illustrated or described herein. In addition, objects distinguished by “first” and “second” are usually of a same type, and a quantity of objects is not limited. For example, there may be one more first objects. Moreover, in the specification and claims, “and/or” indicates at least one of connected objects, and the character “/” usually indicates an “or” relationship between associated objects.

It should be noted that, the technology described in the embodiments of this application is not limited to a Long Term Evolution (LTE)/LTE-Advanced (LTE-A) system, and may be further applied to other wireless communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and another system. The terms “system” and “network” in the embodiments of this application are often used interchangeably. The described technology may be used in the systems and radio technologies mentioned above, and may also be used in another system and radio technology. A New Radio (NR) system is described as an example in the following description, and NR terms are used in most of the following description. However, these technologies may also be applied to an application other than an NR system application, such as a 6^{th} Generation (6G) communication system.

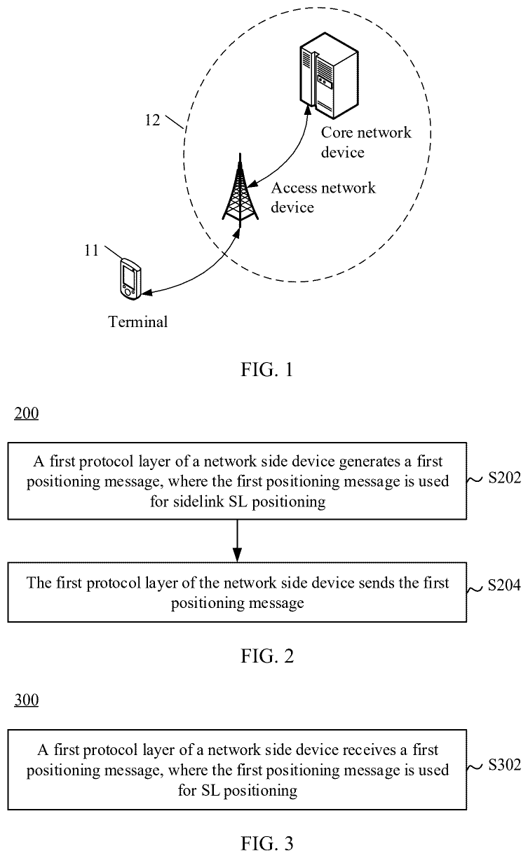

FIG. 1 is a block diagram of a wireless communication system applicable to an embodiment of this application. The wireless communication system includes a terminal 11 and a network side device 12. The terminal 11 may be a mobile phone, a tablet personal computer, a laptop computer, or referred to as a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart household (a household device with a wireless communication function, such as a refrigerator, a television, a washing machine, or furniture), a game console, a Personal Computer (PC), an automated teller machine, a self-service machine, or another terminal side device. The wearable device includes a smartwatch, a smart band, a smart headset, smart glasses, smart jewelry (a smart bracelet, a smart chain bracelet, a smart ring, a smart necklace, a smart anklet, a smart ankle chain, and the like), a smart wrist strap, smart closing, and the like. It should be noted that a specific type of the terminal 11 is not limited in embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a WLAN access point, a WiFi node, and the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting and Receiving Point (TRP), or another appropriate term in the field. The base station is not limited to a specific technical term, provided that a same technical effect is achieved. It should be noted that in the embodiments of this application, only a base station in an NR system is used as an example for description, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF) unit, an Edge Application Server Discovery Function (EASDF), Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (or L-NEF), a Binding Support Function (BSF), an Application Function (AF), and the like. It should be noted that in the embodiments of this application, only a core network device in the NR system is used as an example for description, and a specific type of the core network device is not limited.

The positioning message transmission method, the terminal, and the network side device provided in the embodiments of this application are described below in detail with reference to the accompanying drawings by using some embodiments and application scenarios thereof.

As shown in FIG. 2, an embodiment of this application provides a positioning message transmission method 200. The method may be performed by a network side device. In other words, the positioning message transmission method may be performed by software or hardware installed in the network side device. The positioning message transmission method includes the following steps.

S202: A first protocol layer of the network side device generates a first positioning message, where the first positioning message is used for SL positioning.

The first protocol layer is a positioning protocol layer newly introduced into an original air interface protocol stack architecture. The first protocol layer may provide an SL positioning function, such as definition and exchange of an SL positioning message. Optionally, the first protocol layer may be referred to as a Sidelink Positioning Protocol (SLPP) layer. In this embodiment, in a case that the network side device has an SL positioning requirement or the network side device needs to trigger SL positioning, the first protocol layer of the network side device may generate the first positioning message used for SL positioning. The network side device may be a network side device serving as a positioning server. Optionally, the network side device may be an LMF.

S204: The first protocol layer of the network side device sends the first positioning message.

After the first protocol layer of the network side device generates the first positioning message used for SL positioning, the first protocol layer may send the first positioning message.

In the embodiment of this application, to support a network side device serving as a positioning server in controlling a terminal to perform SL positioning, a protocol layer (that is, a first protocol layer) used to provide an SL positioning function is introduced into an air interface protocol stack architecture in a related technology. During SL positioning, the network side device or the terminal may generate, at the newly introduced protocol layer, a first positioning message used for SL positioning, and may send the first positioning message; or the protocol layer of the network side device or the terminal may receive the first positioning message to perform an SL positioning operation. In this way, the network side device serving as the positioning server can transmit an SL positioning message over an air interface, to control the terminal to perform SL positioning. In addition, an original protocol stack can be further reused to the maximum extent in the embodiments of this application, to support the SL positioning function while ensuring that an air interface positioning function is not affected.

Optionally, in an embodiment, that the first protocol layer of the network side device sends the first positioning message may be that the first protocol layer of the network side device sends the first positioning message to a network side Access and Mobility Management function (AMF) network element. In other words, after generating the first positioning message, the first protocol layer of the network side device may directly send the first positioning message to the AMF. Optionally, when sending the first positioning message to the AMF, the first protocol layer of the network side device may send the first positioning message over an NL1 interface.

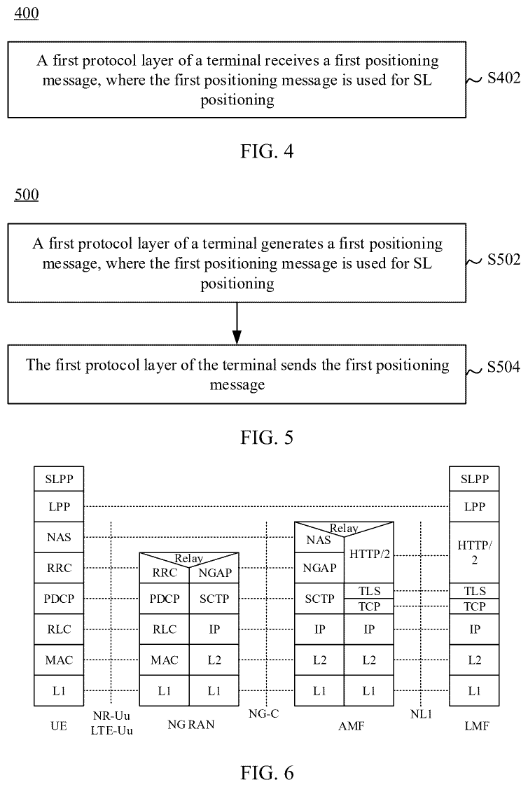

After the AMF receives the first positioning message, a non-access stratum (Non-Access Stratum, NAS) layer of the AMF may generate a NAS message, where the NAS message includes the first positioning message. Then, the NAS layer of the AMF may deliver the NAS message to an NG Application Protocol (NGAP) layer of the AMF. The NGAP layer of the AMF may generate an NGAP message (including the NAS message) based on the NAS message, and may send the NGAP message to an NGAP layer of a peer access network base station over an NG-C interface. After receiving the NGAP message, the access network base station may place the NAS message carried in the NGAP message into a Radio Resource Control (RRC) message, and may send the RRC message to an RRC layer of a peer terminal over an NR-Uu interface. After the RRC layer of the terminal receives the RRC message from the access network base station, the RRC message may be processed by the RRC layer and a NAS layer inside the terminal to obtain the first positioning message, and the first positioning message is delivered to a first protocol layer of the terminal, so that the network side device exchanges an SL positioning message with the terminal by using an air interface protocol stack. For a specific implementation in which the terminal processes the RRC message to obtain the first positioning message, refer to specific implementation of a corresponding step in an embodiment shown in FIG. 4. Details are not described herein.

Optionally, in an embodiment, that the first protocol layer of the network side device sends the first positioning message may be that the first protocol layer of the network side device delivers the first positioning message to an LPP layer of the network side device, where the first protocol layer of the network side device is adjacent to the LPP layer of the network side device and is located at an upper layer of the LPP layer of the network side device. In other words, when the first protocol layer is introduced into the network side device, the first protocol layer may be introduced as an upper layer closely adjacent to the LPP layer. After the first protocol layer of the network side device generates the first positioning message, when sending the first positioning message, the first protocol layer may deliver the first positioning message to the LPP layer which is the lower layer adjacent to the first protocol layer. Delivery may be understood as transmission of the first positioning message between protocol layers inside the network side device.

After receiving the first positioning message, the LPP layer of the network side device may generate an LPP message based on the first positioning message. When the LPP message is generated based on the first positioning message, optionally, a new message type may be introduced, so that an LPP message of the new message type can be generated. The LPP message of the new message type corresponds to the first positioning message.

Optionally, when the LPP message is generated based on the first positioning message, indication information may be carried in the generated LPP message, and the indication information is used to indicate that information carried by the LPP message is the first positioning message, which may specifically include at least one of the following:

In a case that the first positioning message is used for SL capability exchange, the LPP message is used for capability exchange. In other words, when content included in the first positioning message is content of SL capability exchange, the LPP message used to carry the first positioning message should also be a message used for air interface capability exchange.

In a case that the first positioning message is used for SL assistance data exchange, the LPP message is used for assistance data exchange. In other words, when content included in the first positioning message is content of SL assistance data exchange, the LPP message used to carry the first positioning message should also be a message used for air interface assistance data exchange.

In a case that the first positioning message is used for SL location information exchange, the LPP message is used for location information exchange. In other words, when content included in the first positioning message is content of SL location information exchange, the LPP message used to carry the first positioning message should also be a message used for air interface location information exchange.

Optionally, the LPP message may carry a container information element, and the container information element is used to carry the first positioning message.

After generating the LPP message, the LPP layer of the network side device may send the LPP message to an AMF. Optionally, when sending the LPP message to the AMF, the LPP layer of the network side device may send the LPP message to the AMF over an NL1 interface.

After the AMF receives the LPP message, a NAS layer of the AMF may generate a NAS message, where the NAS message includes the LPP message. Then, the NAS layer of the AMF may deliver the NAS message to an NGAP layer of the AMF. The NGAP layer of the AMF may generate an NGAP message (including the NAS message) based on the NAS message, and may send the NGAP message to an NGAP layer of a peer access network base station over an NG-C interface. After receiving the NGAP message, the access network base station may place the NAS message carried in the NGAP message into an RRC message, and may send the RRC message to an RRC layer of a peer terminal over an NR-Uu interface. After the RRC layer of the terminal receives the RRC message from the base station, the RRC message may be processed by the RRC Layer, a NAS layer, and an LPP layer inside the terminal to obtain the first positioning message, and the first positioning message is delivered to a first protocol layer of the terminal, so that the network side device exchanges an SL positioning message with the terminal by using an air interface protocol stack. For a specific implementation in which the terminal processes the RRC message, refer to specific implementation of a corresponding step in an embodiment shown in FIG. 4. Details are not described herein.

In this embodiment of this application, to support a network side device serving as a positioning server in controlling a terminal to perform SL positioning, a protocol layer (that is, a first protocol layer) used to provide an SL positioning function is introduced into an air interface protocol stack architecture in a related technology. During SL positioning, the network side device may generate, at the newly introduced protocol layer, a first positioning message used for SL positioning, and may send the first positioning message. In this way, the network side device serving as the positioning server can transmit an SL positioning message over an air interface, to control the terminal to perform SL positioning. In addition, an original protocol stack can be further reused to the maximum extent in this embodiment of this application, to support the SL positioning function while ensuring that an air interface positioning function is not affected.

As shown in FIG. 3, an embodiment of this application provides a positioning message transmission method 300. The method may be performed by a network side device. In other words, the positioning message transmission method may be performed by software or hardware installed in the network side device. The positioning message transmission method includes the following steps.

S302: A first protocol layer of the network side device receives a first positioning message, where the first positioning message is used for SL positioning.

The first protocol layer is a positioning protocol layer newly introduced into an original air interface protocol stack architecture. The first protocol layer may provide an SL positioning function, such as definition and exchange of an SL positioning message. Optionally, the first protocol layer may be referred to as an SLPP layer. In this embodiment, in a case that a terminal has an SL positioning requirement or the terminal needs to trigger SL positioning, a first protocol layer of the terminal may generate the first positioning message used for SL positioning, and may send the first positioning message. For a specific implementation, refer to specific implementation of a corresponding step in an embodiment shown in FIG. 5. Details are not described herein. In a case that the first protocol layer of the terminal sends the first positioning message, the first protocol layer of the network side device may receive the first positioning message. The network side device may be a network side device serving as a positioning server. Optionally, the network side device may be an LMF.

Optionally, in an embodiment, that the first protocol layer of the network side device receives the first positioning message may be that the first protocol layer of the network side device receives the first positioning message from an AMF. Specifically, after the first protocol layer of the terminal sends the first positioning message, the first positioning message may be processed by a NAS layer (adjacent to the first protocol layer of the terminal and located at a lower layer of the first protocol layer) and an RRC layer inside the terminal to obtain an RRC message. For a specific implementation, refer to a corresponding step in the embodiment shown in FIG. 5. Details are not described herein. The RRC message includes a NAS message, and the NAS message includes the first positioning message.

After obtaining the RRC message, the terminal may send the RRC message to an RRC layer of a peer access network device (for example, an access network base station) over an NR-Uu interface. After receiving the RRC message, the RRC layer of the peer access network device may place the NAS message included in the RRC message into an NGAP message, and an NGAP layer of the access network device sends the NGAP message to an NGAP layer of the AMF over an NG-C interface. After receiving the NGAP message, the NGAP layer of the AMF may deliver the NAS message included in the NGAP message to a NAS layer of the AMF. The NAS layer of the AMF may parse and obtain the first positioning message included in the NAS message. Then, the AMF may send the first positioning message to the network side device over an NL1 interface. In this way, the first protocol layer of the network side device may receive the first positioning message from the AMF, so that the network side device exchanges an SL positioning message with the terminal by using an air interface protocol stack.

Optionally, in an embodiment, that the first protocol layer of the network side device receives the first positioning message may alternatively be that the first protocol layer of the network side device receives the first positioning message from an LPP layer of the network side device, where the first protocol layer of the network side device is adjacent to the LPP layer of the network side device and is located at an upper layer of the LPP layer of the network side device. In other words, when the first protocol layer is introduced into the network side device, the first protocol layer may be introduced as an upper layer closely adjacent to the LPP layer. When receiving the first positioning message, the first protocol layer of the network side device may receive the first positioning message from the LPP layer which is the lower layer adjacent to the first protocol layer.

Optionally, before the first protocol layer of the network side device receives the first positioning message from the LPP layer of the network side device, the method may further include the following steps:

The LPP layer of the network side device receives an LPP message from an AMF.

The LPP layer of the network side device parses the LPP message to obtain the first positioning message, and delivers the first positioning message to the first protocol layer of the network side device.

Specifically, after the first protocol layer of the terminal sends the first positioning message, the first positioning message may be processed by an LPP layer (adjacent to the first protocol layer of the terminal and located at a lower layer of the first protocol layer), a NAS layer, and an RRC layer inside the terminal to obtain an RRC message. For a specific implementation, refer to specific implementation of a corresponding step in the embodiment shown in FIG. 5. Details are not described herein. The RRC message includes a NAS message, and the NAS message includes the LPP message. The LPP message corresponds to the first positioning message (a new message type may be introduced into the LPP message and may generate an LPP message of the new message type corresponding to the first positioning message). Alternatively, the LPP message carries indication information, and the indication information is used to indicate that information carried by the LPP message is the first positioning message. Optionally, the LPP message may carry a container information element, and the container information element is used to carry the first positioning message.

Optionally, the LPP message carries indication information, and the indication information is used to indicate that information carried by the LPP message is the first positioning message, which may specifically include at least one of the following:

In a case that the first positioning message is used for SL capability exchange, the LPP message is used for capability exchange. In other words, when content included in the first positioning message is content of SL capability exchange, the LPP message used to carry the first positioning message should also be a message used for air interface capability exchange.

In a case that the first positioning message is used for SL assistance data exchange, the LPP message is used for assistance data exchange. In other words, when content included in the first positioning message is content of SL assistance data exchange, the LPP message used to carry the first positioning message should also be a message used for air interface assistance data exchange.

In a case that the first positioning message is used for SL location information exchange, the LPP message is used for location information exchange. In other words, when content included in the first positioning message is content of SL location information exchange, the LPP message used to carry the first positioning message should also be a message used for air interface location information exchange.

After obtaining the RRC message, the terminal may send the RRC message to an RRC layer of a peer access network device (for example, an access network base station) over an NR-Uu interface. After receiving the RRC message, the RRC layer of the peer access network device may place the NAS message included in the RRC message into an NGAP message, and an NGAP layer of the access network device sends the NGAP message to an NGAP layer of the AMF over an NG-C interface. After receiving the NGAP message, the NGAP layer of the AMF may deliver the NAS message included in the NGAP message to a NAS layer of the AMF. The NAS layer of the AMF may parse and obtain, the LPP message included in the NAS message. Then, the AMF may send the LPP message to the LPP layer of the network side device over an NL1 interface. In this way, the LPP layer of the network side device may receive the LPP message from the AMF. The LPP message received by the network side device may correspond to the first positioning message (a new message type may be introduced into the LPP message and may generate an LPP message of the new message type corresponding to the first positioning message) sent by the terminal. Alternatively, the LPP message may carry indication information, and the indication information is used to indicate that information carried by the LPP message is the first positioning message. Optionally, the LPP message may carry a container information element, and the container information element is used to carry the first positioning message.

Optionally, the LPP message received by the network side device may carry indication information, and the indication information is used to indicate that information carried by the LPP message is the first positioning message, which may specifically include at least one of the following:

In a case that the first positioning message is used for SL capability exchange, the LPP message is used for capability exchange. In other words, when content included in the first positioning message is content of SL capability exchange, the LPP message used to carry the first positioning message should also be a message used for air interface capability exchange.

In a case that the first positioning message is used for SL assistance data exchange, the LPP message is used for assistance data exchange. In other words, when content included in the first positioning message is content of SL assistance data exchange, the LPP message used to carry the first positioning message should also be a message used for air interface assistance data exchange.

In a case that the first positioning message is used for SL location information exchange, the LPP message is used for location information exchange. In other words, when content included in the first positioning message is content of SL location information exchange, the LPP message used to carry the first positioning message should also be a message used for air interface location information exchange.

After receiving the LPP message, the LPP layer of the network side device may parse the LPP message to obtain the first positioning message, and then deliver the first positioning message to the first protocol layer of the network side device. The first protocol layer of the network side device may receive the first positioning message from the LPP layer of the network side device, so that the network side device exchanges an SL positioning message with the terminal by using an air interface protocol stack.

Optionally, in a case that the first protocol layer of the network side device receives the first positioning message, the network side device may perform a positioning operation based on the first positioning message to implement SL positioning.

In this embodiment of this application, to support a network side device serving as a positioning server in controlling a terminal to perform SL positioning, a protocol layer (that is, a first protocol layer) used to provide an SL positioning function is introduced into an air interface protocol stack architecture in a related technology. During SL positioning, the protocol layer of the network side device may also receive a first positioning message to perform an SL positioning operation. In this way, the network side device serving as the positioning server can transmit an SL positioning message over an air interface, to control the terminal to perform SL positioning. In addition, an original protocol stack can be further reused to the maximum extent in this embodiment of this application, to support the SL positioning function while ensuring that an air interface positioning function is not affected.

As shown in FIG. 4, an embodiment of this application provides a positioning message transmission method 400. The method may be performed by a terminal. In other words, the positioning message transmission method may be performed by software or hardware installed in the terminal. The positioning message transmission method includes the following step.

S402: A first protocol layer of the terminal receives a first positioning message, where the first positioning message is used for SL positioning.

The first protocol layer is a positioning protocol layer newly introduced into an original air interface protocol stack architecture. The first protocol layer may provide an SL positioning function, such as definition and exchange of an SL positioning message. Optionally, the first protocol layer may be referred to as an SLPP layer. In this embodiment, in a case that a network side device has an SL positioning requirement or the network side device needs to trigger SL positioning, a first protocol layer of the network side device may generate the first positioning message used for SL positioning, and may send the first positioning message. For a specific implementation, refer to specific implementation of a corresponding step in the embodiment shown in FIG. 2. Details are not described herein. In a case that the first protocol layer of the network side device sends the first positioning message, the first protocol layer of the terminal may receive the first positioning message. The network side device may be a network side device serving as a positioning server. Optionally, the network side device may be an LMF.

Optionally, in an embodiment, that the first protocol layer of the terminal receives the first positioning message may be that the first protocol layer of the terminal receives the first positioning message from an LPP layer of the terminal, where the first protocol layer of the terminal is adjacent to the LPP layer of the terminal and is located at an upper layer of the LPP layer of the terminal. In other words, when the first protocol layer is introduced as the terminal, the first protocol layer may be introduced as an upper layer closely adjacent to the LPP layer. When receiving the first positioning message, the first protocol layer of the terminal may receive the first positioning message from the LPP layer which is the lower layer adjacent to the first protocol layer.

Optionally, before the first protocol layer of the terminal receives the first positioning message from the LPP layer of the terminal, the method may further include the following steps:

An RRC layer of the terminal receives an RRC message from an RRC layer of a peer access network device, where the RRC message includes a NAS message, and the NAS message includes an LPP message.

The RRC layer of the terminal delivers the NAS message carried in the RRC message to a NAS layer of the terminal.

The NAS layer of the terminal receives the NAS message, and delivers the LPP message carried in the NAS message to the LPP layer of the terminal.

The LPP layer of the terminal receives and parses the LPP message to obtain the first positioning message, and delivers the first positioning message to the first protocol layer of the terminal.

Specifically, when sending the first positioning message, the first protocol layer of the network side device may deliver the first positioning message to an LPP layer (adjacent to the first protocol layer of the network side device and located at a lower layer of the first protocol layer) of the network side device. The LPP layer may generate an LPP message based on the first positioning message. For a specific implementation, refer to specific implementation of a corresponding step in the embodiment shown in FIG. 2. Details are not described herein.

After generating the LPP message, the network side device may send the LPP message to an AMF over an NL1 interface. After the AMF receives the LPP message, a NAS layer of the AMF may generate a NAS message, where the NAS message includes the LPP message. Then, the NAS layer of the AMF may deliver the NAS message to an NGAP layer of the AMF. The NGAP layer of the AMF may generate an NGAP message (including the NAS message) based on the NAS message, and may send the NGAP message to an NGAP layer of a peer access network base station over an NG-C interface. After receiving the NGAP message, the access network base station may place the NAS message carried in the NGAP message into an RRC message, and may send the RRC message to the RRC layer of the peer terminal over an NR-Uu interface. In this way, the RRC layer of the terminal may receive the RRC message from the peer access network base station (that is, the peer access network device). The RRC message received by the terminal includes the NAS message, and the NAS message includes the LPP message. The LPP message corresponds to the first positioning message (a new message type may be introduced into the LPP message and may generate an LPP message of the new message type corresponding to the first positioning message) sent by the network side device. Alternatively, the LPP message carries indication information, and the indication information is used to indicate that information carried by the LPP message is the first positioning message. Optionally, the LPP message may carry a container information element, and the container information element is used to carry the first positioning message.

Optionally, the LPP message carries indication information, and the indication information is used to indicate that information carried by the LPP message is the first positioning message, which may specifically include at least one of the following:

In a case that the first positioning message is used for SL capability exchange, the LPP message is used for capability exchange. In other words, when content included in the first positioning message is content of SL capability exchange, the LPP message used to carry the first positioning message should also be a message used for air interface capability exchange.

In a case that the first positioning message is used for SL assistance data exchange, the LPP message is used for assistance data exchange. In other words, when content included in the first positioning message is content of SL assistance data exchange, the LPP message used to carry the first positioning message should also be a message used for air interface assistance data exchange.

In a case that the first positioning message is used for SL location information exchange, the LPP message is used for location information exchange. In other words, when content included in the first positioning message is content of SL location information exchange, the LPP message used to carry the first positioning message should also be a message used for air interface location information exchange.

After receiving the RRC message, the RRC layer of the terminal may deliver the NAS message carried in the RRC message to the NAS layer of the terminal. After receiving the NAS message, the NAS layer of the terminal may deliver the LPP message carried in the NAS message to the LPP layer of the terminal. After receiving the LPP message, the LPP layer of the terminal may parse the LPP message to obtain the first positioning message, and then deliver the first positioning message to the first protocol layer of the terminal. The first protocol layer of the terminal may receive the first positioning message, so that the network side device exchanges an SL positioning message with the terminal by using an air interface protocol stack.

Optionally, in an embodiment, that the first protocol layer of the terminal receives the first positioning message may alternatively be that the first protocol layer of the terminal receives the first positioning message from a NAS layer of the terminal, where the first protocol layer of the terminal is adjacent to the NAS layer of the terminal and is located at an upper layer of the NAS layer of the terminal. In other words, when the first protocol layer is introduced into the terminal, the first protocol layer may be introduced as an upper layer closely adjacent to the NAS layer. When receiving the first positioning message, the first protocol layer of the terminal may receive the first positioning message from the NAS layer which is the lower layer adjacent to the first protocol layer.

Optionally, before the first protocol layer of the terminal receives the first positioning message from the NAS layer of the terminal, the method may further include the following steps:

An RRC layer of the terminal receives an RRC message from an RRC layer of a peer access network device, where the RRC message includes a NAS message, and the NAS message includes the first positioning message.

The RRC layer of the terminal delivers the NAS message carried in the RRC message to the NAS layer of the terminal.

The NAS layer of the terminal receives the NAS message, and delivers the first positioning message carried in the NAS message to the first protocol layer of the terminal.

Specifically, when sending the first positioning message, the first protocol layer of the network side device may send the first positioning message to an AMF. Optionally, the network side device may send the first positioning message to the AMF over an NL1 interface. After the AMF receives the first positioning message, a NAS layer of the AMF may generate a NAS message, where the NAS message includes the first positioning message. Then, the NAS layer of the AMF may deliver the NAS message to an NGAP layer of the AMF. The NGAP layer of the AMF may generate an NGAP message (including the NAS message) based on the NAS message, and may send the NGAP message to an NGAP layer of a peer access network base station over an NG-C interface. After receiving the NGAP message, the access network base station may place the NAS message carried in the NGAP message into an RRC message, and may send the RRC message to the RRC layer of the peer terminal over an NR-Uu interface. In this way, the RRC layer of the terminal may receive the RRC message from the peer access network base station (that is, the peer access network device). The RRC message received by the terminal includes the NAS message, and the NAS message includes the first positioning message.

After receiving the RRC message, the RRC layer of the terminal may deliver the NAS message carried in the RRC message to the NAS layer of the terminal. After receiving the NAS message, the NAS layer of the terminal may deliver the first positioning message carried in the NAS message to the first protocol layer of the terminal, and the first protocol layer of the terminal may receive the first positioning message, so that the network side device exchanges an SL positioning message with the terminal by using an air interface protocol stack.

Optionally, in a case that the first protocol layer of the terminal receives the first positioning message, the terminal may perform an SL positioning operation based on the first positioning message to implement SL positioning.

In this embodiment of this application, to support a network side device serving as a positioning server in controlling a terminal to perform SL positioning, a protocol layer (that is, a first protocol layer) used to provide an SL positioning function is introduced into an air interface protocol stack architecture in a related technology. During SL positioning, the protocol layer of the terminal may receive a first positioning message to perform an SL positioning operation. In this way, the network side device serving as the positioning server can transmit an SL positioning message over an air interface, in order to control the terminal to perform SL positioning. In addition, an original protocol stack can be further reused to the maximum extent in this embodiment of this application, to support the SL positioning function while ensuring that an air interface positioning function is not affected.

As shown in FIG. 5, an embodiment of this application provides a positioning message transmission method 500. The method may be performed by a terminal. In other words, the positioning message transmission method may be performed by software or hardware installed in the terminal. The positioning message transmission method includes the following steps.

S502: A first protocol layer of the terminal generates a first positioning message, where the first positioning message is used for SL positioning.

The first protocol layer is a positioning protocol layer newly introduced into an original air interface protocol stack architecture. The first protocol layer may provide an SL positioning function, such as definition and exchange of an SL positioning message. Optionally, the first protocol layer may be referred to as an SLPP layer. In this embodiment, in a case that the terminal has an SL positioning requirement or the terminal needs to trigger SL positioning, the first protocol layer of the terminal may generate the first positioning message used for SL positioning.

S504: The first protocol layer of the terminal sends the first positioning message.

After the first protocol layer of the terminal generates the first positioning message used for SL positioning, the first protocol layer may send the first positioning message.

Optionally, in an embodiment, that the first protocol layer of the terminal sends the first positioning message may be that the first protocol layer of the terminal delivers the first positioning message to an LPP layer of the terminal, where the first protocol layer of the terminal is adjacent to the LPP layer of the terminal and is located at an upper layer of the LPP layer of the terminal. In other words, when the first protocol layer is introduced into the terminal, the first protocol layer may be introduced as an upper layer closely adjacent to the LPP layer. After the first protocol layer of the terminal generates the first positioning message, when sending the first positioning message, the first protocol layer may deliver the first positioning message to the LPP layer which is the lower layer adjacent to the first protocol layer. Delivery may be understood as transmission of the first positioning message between protocol layers inside the terminal.

Optionally, after the first protocol layer of the terminal delivers the first positioning message to the LPP layer of the terminal, the method may further include the following steps:

The LPP layer of the terminal generates an LPP message based on the first positioning message, and delivers the LPP message to a NAS layer of the terminal.

The NAS layer of the terminal delivers a NAS message to an RRC layer of the terminal, where the NAS message includes the LPP message.

The RRC layer of the terminal sends an RRC message to an RRC layer of a peer access network device, where the RRC message includes the NAS message.

Specifically, after receiving the first positioning message, the LPP layer of the terminal may generate the LPP message based on the first positioning message. When the LPP message is generated based on the first positioning message, optionally, a new message type may be introduced, so that an LPP message of the new message type can be generated. The LPP message of the new message type corresponds to the first positioning message.

Optionally, when the LPP message is generated based on the first positioning message, indication information may be carried in the generated LPP message, and the indication information is used to indicate that information carried by the LPP message is the first positioning message, which may specifically include at least one of the following:

In a case that the first positioning message is used for SL capability exchange, the LPP message is used for capability exchange. In other words, when content included in the first positioning message is content of SL capability exchange, the LPP message used to carry the first positioning message should also be a message used for air interface capability exchange.

In a case that the first positioning message is used for SL assistance data exchange, the LPP message is used for assistance data exchange. In other words, when content included in the first positioning message is content of SL assistance data exchange, the LPP message used to carry the first positioning message should also be a message used for air interface assistance data exchange.

In a case that the first positioning message is used for SL location information exchange, the LPP message is used for location information exchange. In other words, when content included in the first positioning message is content of SL location information exchange, the LPP message used to carry the first positioning message should also be a message used for air interface location information exchange.

Optionally, the LPP message may carry a container information element, and the container information element is used to carry the first positioning message.

After generating the LPP message, the LPP layer of the terminal may deliver the LPP message to the NAS layer of the terminal, where the NAS layer is adjacent to the LPP layer of the terminal and is located at a lower layer of the LPP layer. After receiving the NAS message, the NAS layer of the terminal may deliver the NAS message to the RRC layer of the terminal, where the RRC layer is adjacent to the NAS layer of the terminal and is located at a lower layer of the NAS layer, and the NAS message includes the LPP message. After receiving the NAS message, the RRC layer of the terminal may send the RRC message to the RRC layer of the peer access network device, where the RRC message includes the NAS message, and the peer access network device may be a peer access network base station. Optionally, when sending the RRC message to the RRC layer of the peer access network device, the RRC layer of the terminal may send the RRC message over an NR-Uu interface.

After receiving the RRC message, the RRC layer of the peer access network device may place the NAS message included in the RRC message into an NGAP message, and an NGAP layer of the access network device sends the NGAP message to an NGAP layer of an AMF over an NG-C interface. After receiving the NGAP message, the NGAP layer of the AMF may deliver the NAS message included in the NGAP message to a NAS layer of the AMF. The NAS layer of the AMF may parse and obtain, the LPP message included in the NAS message. Then, the AMF may send the LPP message to an LPP layer of the network side device over an NL1 interface. After receiving the LPP message from the AMF, the LPP layer of the network side device may parse the LPP message to obtain the first positioning message, and deliver the first positioning message to a first protocol layer of the network side device, so that the network side device exchanges an SL positioning message with the terminal by using an air interface protocol stack. The network side device may be a network side device serving as a positioning server. Optionally, the network side device may be an LMF. The LPP message received by the network side device may correspond to the first positioning message (a new message type may be introduced into the LPP message and may generate an LPP message of the new message type corresponding to the first positioning message) sent by the terminal. Alternatively, the LPP message may carry indication information, and the indication information is used to indicate that information carried by the LPP message is the first positioning message. Optionally, the LPP message may carry a container information element, and the container information element is used to carry the first positioning message.

Optionally, the LPP message may carry indication information, and the indication information is used to indicate that information carried by the LPP message is the first positioning message, which may specifically include at least one of the following:

In a case that the first positioning message is used for SL capability exchange, the LPP message is used for capability exchange. In other words, when content included in the first positioning message is content of SL capability exchange, the LPP message used to carry the first positioning message should also be a message used for air interface capability exchange.

In a case that the first positioning message is used for SL assistance data exchange, the LPP message is used for assistance data exchange. In other words, when content included in the first positioning message is content of SL assistance data exchange, the LPP message used to carry the first positioning message should also be a message used for air interface assistance data exchange.

In a case that the first positioning message is used for SL location information exchange, the LPP message is used for location information exchange. In other words, when content included in the first positioning message is content of SL location information exchange, the LPP message used to carry the first positioning message should also be a message used for air interface location information exchange.

Optionally, in an embodiment, that the first protocol layer of the terminal sends the first positioning message may alternatively be that the first protocol layer of the terminal delivers the first positioning message to a NAS layer of the terminal, where the first protocol layer of the terminal is adjacent to the NAS layer of the terminal and is located at an upper layer of the NAS layer of the terminal. In other words, when the first protocol layer is introduced into the terminal, the first protocol layer may be introduced as an upper layer closely adjacent to the NAS layer.

After the first protocol layer of the terminal generates the first positioning message, when sending the first positioning message, the first protocol layer may deliver the first positioning message to the NAS layer which is the lower layer adjacent to the first protocol layer.

Optionally, after the first protocol layer of the terminal delivers the first positioning message to the NAS layer of the terminal, the method may further include the following steps:

The NAS layer of the terminal delivers a NAS message to an RRC layer of the terminal, where the NAS message includes the first positioning message.

The RRC layer of the terminal sends an RRC message to an RRC layer of a peer access network device, where the RRC message includes the NAS message.

Specifically, after receiving the first positioning message, the NAS layer of the terminal may generate the NAS message based on the first positioning message, where the NAS message includes the first positioning message. Then, the NAS layer of the terminal may deliver the NAS message to the RRC layer of the terminal, where the RRC layer is adjacent to the NAS layer of the terminal and is located at a lower layer of the NAS layer. After receiving the NAS message, the RRC layer of the terminal may send the RRC message to the RRC layer of the peer access network device, where the RRC message includes the NAS message, and the peer access network device may be a peer access network base station. When sending the RRC message to the RRC layer of the peer access network device, the RRC layer of the terminal may send the RRC message over an NR-Uu interface.

After receiving the RRC message, the RRC layer of the peer access network device may place the NAS message included in the RRC message into an NGAP message, and an NGAP layer of the access network device sends the NGAP message to an NGAP layer of an AMF over an NG-C interface. After receiving the NGAP message, the NGAP layer of the AMF may deliver the NAS message included in the NGAP message to a NAS layer of the AMF. The NAS layer of the AMF may parse and obtain, the first positioning message included in the NAS message. Then, the AMF may send the first positioning message to a first protocol layer of the network side device over an NL1 interface, so that the network side device exchanges an SL positioning message with the terminal by using an air interface protocol stack. The network side device may be a network side device serving as a positioning server. Optionally, the network side device may be an LMF.

In this embodiment of this application, to support a network side device serving as a positioning server in controlling a terminal to perform SL positioning, a protocol layer (that is, a first protocol layer) used to provide an SL positioning function is introduced into an air interface protocol stack architecture in a related technology. During SL positioning, the terminal may generate, at the newly introduced protocol layer, a first positioning message used for SL positioning, and may send the first positioning message. In this way, the network side device serving as the positioning server can transmit an SL positioning message over an air interface, to control the terminal to perform SL positioning. In addition, an original protocol stack can be further reused to the maximum extent in this embodiment of this application, to support the SL positioning function while ensuring that an air interface positioning function is not affected.

To facilitate understanding of the technical solutions provided in the embodiments of this application, the following may provide description by using two scenarios in which an LMF sends a first positioning message to UE as examples.

Embodiment 1: A first protocol layer is adjacent to an LPP layer and is located at an upper layer of the LPP layer.

FIG. 6 shows a location relationship between the first protocol layer and a protocol layer in a related technology. For ease of description, the first protocol layer may be represented as an SLPP layer, and the first positioning message may be represented as an SLPP message. As shown in FIG. 6, on the LMF side, the SLPP layer is adjacent to the LPP layer and is located at the upper layer of the LPP layer. On the UE side, the SLPP layer is adjacent to the LPP layer and is located at the upper layer of the LPP layer.

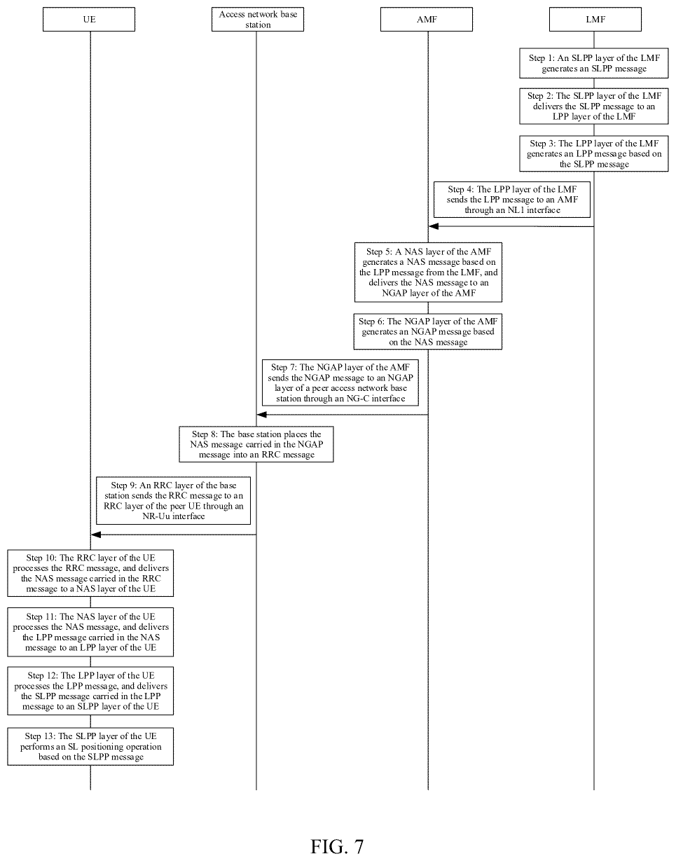

Based on a protocol stack architecture shown in FIG. 6, a specific implementation in which the LMF exchanges the SLPP message with the UE may be shown in FIG. 7. The embodiment shown in FIG. 7 may include the following steps.

Step 1: The SLPP layer of the LMF generates the SLPP message.

When the LMF needs to perform SL positioning, the LMF may generate, at the SLPP layer, the SLPP message that needs to be sent to a peer terminal (UE).

Step 2: The SLPP layer of the LMF delivers the SLPP message to the LPP layer of the LMF.

Step 3: The LPP layer of the LMF generates an LPP message based on the SLPP message.

The SLPP message is carried in the LPP message. Specifically, a new message type may be introduced into an LPP protocol to generate an LPP message that is of the new message type and that corresponds to the first positioning message. Alternatively, indication information may be added to the LPP message, and the indication information is used to indicate that the LPP message transmits the SLPP message. Specifically, in a case that the first positioning message is used for SL capability exchange, the LPP message is used for capability exchange; in a case that the first positioning message is used for SL assistance data exchange, the LPP message is used for assistance data exchange; and in a case that the first positioning message is used for SL location information exchange, the LPP message is used for location information exchange.

The LPP message may carry a container (byte stream) information element, and the container information element corresponds to the SLPP message. The LPP layer does not pay attention to actual content of the SLPP message, but only helps transfer of the SLPP message at a lower layer.

Step 4: The LPP layer of the LMF sends the LPP message to an AMF over an NL1 interface.

Step 5: A NAS layer of the AMF generates a NAS message based on the LPP message from the LMF, and delivers the NAS message to an NGAP layer of the AMF.

The NAS message is a downlink non-access stratum transport message (DL NAS Transport message), and the NAS message includes the LPP message from the LMF.

Step 6: The NGAP layer of the AMF generates an NGAP message based on the NAS message.

The NGAP message is a downlink non-access stratum transport message transparently transmitted by an NG interface application protocol, where the NGAP message includes the NAS message.

Step 7: The NGAP layer of the AMF sends the NGAP message to an NGAP layer of a peer access network base station over an NG-C interface.

Step 8: The base station places the NAS message carried in the NGAP message into an RRC message.

Step 9: An RRC layer of the base station sends the RRC message to an RRC layer of the peer UE over an NR-Uu interface.

Step 10: The RRC layer of the UE processes the RRC message, and delivers the NAS message carried in the RRC message to a NAS layer of the UE.

Step 11: The NAS layer of the UE processes the NAS message, and delivers the LPP message carried in the NAS message to the LPP layer of the UE.

Step 12: The LPP layer of the UE processes the LPP message, and delivers the SLPP message carried in the LPP message to the SLPP layer of the UE.

Step 13: The SLPP layer of the UE performs an SL positioning operation based on the SLPP message.

In an architecture in which an LMF serves as a positioning server to exchange an SL positioning message with a terminal, the SL positioning message is transmitted by introducing a container information element into an LPP layer, which has a minimum impact on a protocol structure in a related technology. In addition, this protocol stack design can meet two scenarios: air interface positioning and SL positioning. In a scenario in which only SL positioning is considered, the LMF may serve as a positioning server to indicate an SL positioning operation of a terminal in a connected state by using an SLPP message. An LPP message may have only a function of serving as a container of the SLPP message, and does not have the air interface positioning function in another LPP protocol.

Embodiment 2: A first protocol layer is adjacent to a NAS layer and is located at an upper layer of the NAS layer

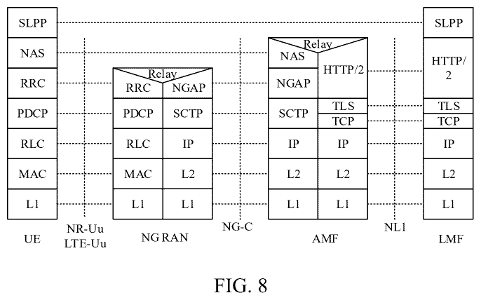

FIG. 8 shows a location relationship between the first protocol layer and a protocol layer in a related technology. For ease of description, the first protocol layer may be represented as an SLPP layer, and the first positioning message may be represented as an SLPP message. As shown in FIG. 8, on the LMF side, the SLPP layer is adjacent to an HTTP/2 layer and is located at an upper layer of the HTTP/2 layer. On the UE side, the SLPP layer is adjacent to a NAS layer and is located at an upper layer of the NAS layer. It should be noted that FIG. 8 does not show LPP layers on the LMF side and the UE side, that is, a location relationship between the LPP layer and the SLPP layer is not specifically limited.

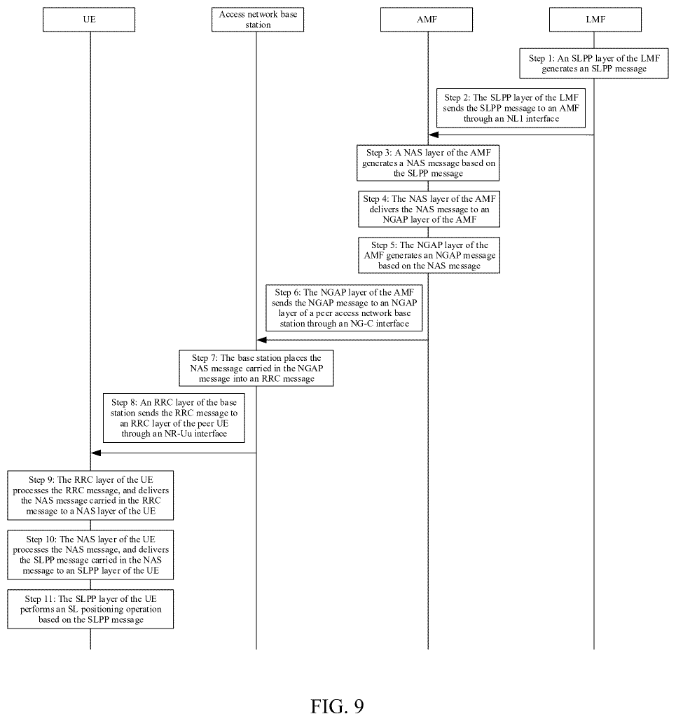

Based on a protocol stack architecture shown in FIG. 8, a specific implementation in which the LMF exchanges the SLPP message with the UE may be shown in FIG. 9. The embodiment shown in FIG. 9 may include the following steps.

Step 1: The SLPP layer of the LMF generates the SLPP message.

When the LMF needs to perform SL positioning, the LMF may generate, at the SLPP layer, the SLPP message that needs to be sent to a peer terminal (UE).

Step 2: The SLPP layer of the LMF sends the SLPP message to an AMF over an NL1 interface.

Step 3: A NAS layer of the AMF generates a NAS message based on the SLPP message.

The SLPP message is carried in the NAS message. For example, the NAS message carries a container (byte stream) information element, and the container information element corresponds to the SLPP message. The NAS layer does not pay attention to actual content of the SLPP message, but only helps transfer of the SLPP message at a lower layer.

Step 4: The NAS layer of the AMF delivers the NAS message to an NGAP layer of the AMF.

Step 5: The NGAP layer of the AMF generates an NGAP message based on the NAS message. The NGAP message is a downlink non-access stratum transport message transparently transmitted by an NG interface application protocol, where the NGAP message includes the NAS message.

Step 6: The NGAP layer of the AMF sends the NGAP message to an NGAP layer of a peer access network base station over an NG-C interface.

Step 7: The base station places the NAS message carried in the NGAP message into an RRC message.

Step 8: An RRC layer of the base station sends the RRC message to an RRC layer of the peer UE over an NR-Uu interface.

Step 9: The RRC layer of the UE processes the RRC message, and delivers the NAS message carried in the RRC message to a NAS layer of the UE.

Step 10: The NAS layer of the UE processes the NAS message, and delivers the SLPP message carried in the NAS message to the SLPP layer of the UE.

Step 11: The SLPP layer of the UE performs an SL positioning operation based on the SLPP message.

In an architecture in which an LMF serves as a positioning server to exchange an SL positioning message with a terminal, the SL positioning message is transmitted by introducing a container information element into a NAS layer, and different protocols used by the LMF to respectively control air interface positioning and SL positioning are more clearly distinguished. The terminal controlled by the LMF may implement an air interface positioning-related function by using an LPP message, and implement an SL positioning-related function by using an SLPP message. Both the LPP message and the SLPP message are transmitted by using a NAS message.

In embodiments of this application, to support a network side device serving as a positioning server in controlling a terminal to perform SL positioning, a protocol layer (that is, a first protocol layer) used to provide an SL positioning function is introduced into an air interface protocol stack architecture in a related technology. During SL positioning, the network side device or the terminal may generate, at the newly introduced protocol layer, a first positioning message used for SL positioning, and may send the first positioning message; or the protocol layer of the network side device or the terminal may receive the first positioning message to perform an SL positioning operation. In this way, the network side device serving as the positioning server can transmit an SL positioning message over an air interface, to control the terminal to perform SL positioning. In addition, an original protocol stack can be further reused to the maximum extent in the embodiments of this application, to support the SL positioning function while ensuring that an air interface positioning function is not affected.

The positioning message transmission method provided in the embodiments of this application may be performed by a positioning message transmission apparatus. In the embodiments of this application, that the positioning message transmission apparatus performs the positioning message transmission method is used as an example to describe the positioning message transmission apparatus provided in the embodiments of this application.

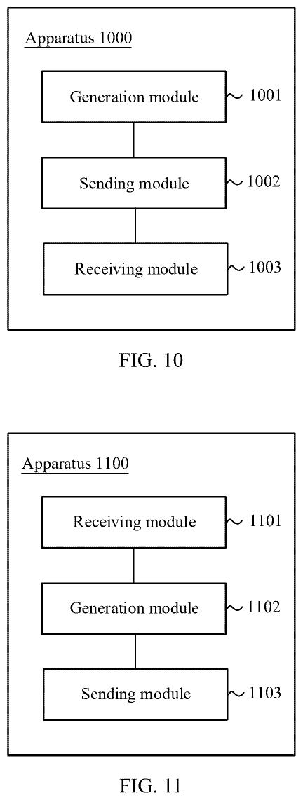

FIG. 10 is a schematic diagram of a structure of a positioning message transmission apparatus according to an embodiment of this application. The apparatus may correspond to the network side device in other embodiments. As shown in FIG. 10, the apparatus 1000 includes the following modules:
a generation module 1001, configured to generate a first positioning message, where the first positioning message is used for SL positioning; and a sending module 1002, configured to send the first positioning message; and
a receiving module 1003, configured to receive the first positioning message.

Optionally, in an embodiment, the sending module 1002 is configured to perform any one of the following:
sending the first positioning message to an AMF; or
delivering the first positioning message to an LPP layer of a network side device, where a first protocol layer of the network side device is adjacent to the LPP layer of the network side device and is located at an upper layer of the LPP layer of the network side device.

Optionally, in an embodiment, the generation module 1001 is further configured to generate an LPP message based on the first positioning message.

The sending module 1002 is further configured to send the LPP message to the AMF.

Optionally, in an embodiment, the receiving module 1003 is configured to perform any one of the following:
receiving the first positioning message from an AMF; or
receiving the first positioning message from an LPP layer of a network side device, where a first protocol layer of the network side device is adjacent to the LPP layer of the network side device and is located at an upper layer of the LPP layer of the network side device.

Optionally, in an embodiment, the receiving module 1003 is further configured to:
receive an LPP message from an AMF; and
parse the LPP message to obtain the first positioning message, and deliver the first positioning message to the first protocol layer of the network side device.

Optionally, in an embodiment, the LPP message corresponds to the first positioning message; or
the LPP message includes indication information, and the indication information is used to indicate that a message carried by the LPP message is the first positioning message.

Optionally, in an embodiment, in a case that the LPP message includes the indication information, at least one of the following is included:
in a case that the first positioning message is used for SL capability exchange, the LPP message is used for capability exchange;
in a case that the first positioning message is used for SL assistance data exchange, the LPP message is used for assistance data exchange; and
in a case that the first positioning message is used for SL location information exchange, the LPP message is used for location information exchange.

Optionally, in an embodiment, the LPP message carries a container information element, and the container information element is used to carry the first positioning message.

Optionally, in an embodiment, the apparatus 1000 further includes a positioning module 1004.

The positioning module 1004 is configured to perform an SL positioning operation based on the first positioning message.

The apparatus 1000 according to this embodiment of this application may refer to procedures corresponding to the method 200 and the method 300 in embodiments of this application. In addition, units/modules in the apparatus 1000 and other operations and/or functions described above are respectively used to implement the corresponding procedures in the method 200 and the method 300, and same or equivalent technical effects can be achieved. For brevity, details are not described herein again.

FIG. 11 is a schematic diagram of a structure of a positioning message transmission apparatus according to an embodiment of this application. The apparatus may correspond to the terminal in other embodiments. As shown in FIG. 11, the apparatus 1100 includes the following modules:
a receiving module 1101, configured to receive a first positioning message, where the first positioning message is used for SL positioning; and
a generation module 1102, configured to generate the first positioning message; and a sending module 1103, configured to send the first positioning message.

Optionally, in an embodiment, the receiving module 1101 is configured to perform any one of the following:
receiving the first positioning message from an LPP layer of a terminal, where a first protocol layer of the terminal is adjacent to the LPP layer of the terminal and is located at an upper layer of the LPP layer of the terminal; or
receiving the first positioning message from a NAS layer of the terminal, where the first protocol layer of the terminal is adjacent to the NAS layer of the terminal and is located at an upper layer of the NAS layer of the terminal.

Optionally, in an embodiment, the receiving module 1101 is further configured to:
receive an RRC message from an RRC layer of a peer access network device, where the RRC message includes a NAS message, and the NAS message includes an LPP message;
deliver the NAS message carried in the RRC message to the NAS layer of the terminal;
receive the NAS message, and deliver the LPP message carried in the NAS message to the LPP layer of the terminal; and
receive and parse the LPP message to obtain the first positioning message, and deliver the first positioning message to the first protocol layer of the terminal.

Optionally, in an embodiment, the receiving module 1101 is further configured to:
receive an RRC message from an RRC layer of a peer access network device, where the RRC message includes a NAS message, and the NAS message includes the first positioning message;
deliver the NAS message carried in the RRC message to the NAS layer of the terminal; and
receive the NAS message, and deliver the first positioning message carried in the NAS message to the first protocol layer of the terminal.

Optionally, in an embodiment, the apparatus 1100 further includes a positioning module 1104.

The positioning module 1104 is configured to perform an SL positioning operation based on the first positioning message.

Optionally, in an embodiment, the sending module 1103 includes any one of the following:
delivering the first positioning message to an LPP layer of a terminal, where a first protocol layer of the terminal is adjacent to the LPP layer of the terminal and is located at an upper layer of the LPP layer of the terminal; or
delivering the first positioning message to a NAS layer of the terminal, where the first protocol layer of the terminal is adjacent to the NAS layer of the terminal and is located at an upper layer of the NAS layer of the terminal.

Optionally, in an embodiment, the sending module 1103 is further configured to:
generate an LPP message based on the first positioning message, and deliver the LPP message to the NAS layer of the terminal;
deliver a NAS message to an RRC layer of the terminal, where the NAS message includes the LPP message; and
send an RRC message to an RRC layer of a peer access network device, where the RRC message includes the NAS message.

Optionally, in an embodiment, the sending module 1103 is further configured to:
deliver a NAS message to an RRC layer of the terminal, where the NAS message includes the first positioning message; and
send an RRC message to an RRC layer of a peer access network device, where the RRC message includes the NAS message.

Optionally, in an embodiment, the LPP message corresponds to the first positioning message; or
the LPP message includes indication information, and the indication information is used to indicate that a message carried by the LPP message is the first positioning message.

Optionally, in an embodiment, in a case that the LPP message includes the indication information, at least one of the following is included:
in a case that the first positioning message is used for SL capability exchange, the LPP message is used for capability exchange;
in a case that the first positioning message is used for SL assistance data exchange, the LPP message is used for assistance data exchange; and
in a case that the first positioning message is used for SL location information exchange, the LPP message is used for location information exchange.

Optionally, in an embodiment, the LPP message carries a container information element, and the container information element is used to carry the first positioning message.

Optionally, in an embodiment, the NAS message carries a container information element, and the container information element is used to carry the first positioning message.

The apparatus 1100 according to this embodiment of this application may refer to procedures corresponding to the method 400 and the method 500 in embodiments of this application. In addition, units/modules in the apparatus 1100 and other operations and/or functions described above are respectively used to implement the corresponding procedures in the method 400 and the method 500, and same or equivalent technical effects can be achieved. For brevity, details are not described herein again.

The positioning message transmission apparatus in the embodiments of this application may be an electronic device, for example, an electronic device with an operating system; or may be a component in an electronic device, for example, an integrated circuit or a chip. The electronic device may be a terminal, or may be a device other than the terminal. For example, the terminal may include but is not limited to the types of the terminal 11 listed above. Another device may be a server, a Network Attached Storage (NAS), or the like. This is not specifically limited in the embodiments of this application.

The positioning message transmission apparatus provided in the embodiments of this application can implement processes implemented in the method embodiments in FIG. 2 to FIG. 5, and achieve same technical effects. To avoid repetition, details are not described herein again.

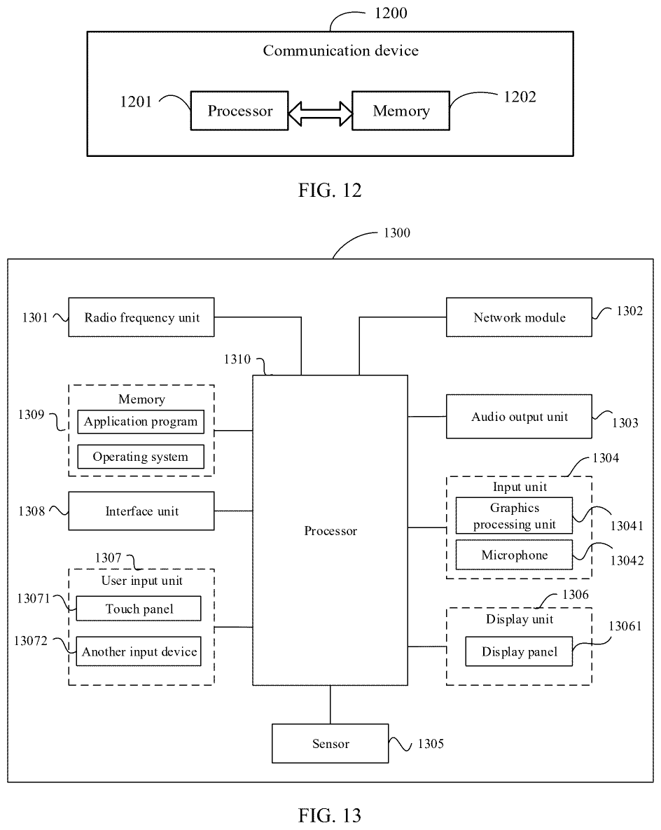

Optionally, as shown in FIG. 12, an embodiment of this application further provides a communication device 1200, including a processor 1201 and a memory 1202. The memory 1202 stores a program or instructions that are capable of running on the processor 1201. For example, when the communication device 1200 is a terminal, the program or the instructions are executed by the processor 1201 to implement the steps in the foregoing embodiment of the positioning message transmission method, and same technical effects can be achieved. When the communication device 1200 is a network side device, the program or the instructions are executed by the processor 1201 to implement the steps in the foregoing embodiment of the positioning message transmission method, and same technical effects can be achieved. To avoid repetition, details are not described herein again.

An embodiment of this application further provides a terminal, including a processor and a communication interface. The communication interface is configured to receive a first positioning message, where the first positioning message is used for SL positioning. Alternatively, the processor is configured to generate the first positioning message, and the communication interface is configured to send the first positioning message. The terminal embodiment corresponds to the foregoing terminal-side method embodiment. Each implementation process and implementation of the foregoing method embodiment may be applied to the terminal embodiment, and same technical effects can be achieved. Specifically, FIG. 13 is a schematic diagram of a hardware structure of a terminal according to an embodiment of this application.

The terminal 1300 includes but is not limited to at least some of the following components: a radio frequency unit 1301, a network module 1302, an audio output unit 1303, an input unit 1304, a sensor 1305, a display unit 1306, a user input unit 1307, an interface unit 1308, a memory 1309, and a processor 1310.

A person skilled in the art may understand that, the terminal 1300 may further include a power supply (such as a battery) that supplies power to each component. The power supply may be logically connected to the processor 1310 by using a power management system, to implement functions such as charging management, discharging management, and power consumption management by using the power management system. The structure of the terminal shown in FIG. 13 does not constitute any limitation on the terminal. The terminal may include more or fewer components than those shown in the figure, or combine some components, or have different component arrangements. Details are not described herein.

It should be understood that in this embodiment of this application, the input unit 1304 may include a Graphics Processing Unit (GPU) 13041 and a microphone 13042. The GPU 13041 processes image data of a still picture or a video obtained by an image capture apparatus (such as a camera) in a video capture mode or an image capture mode. The display unit 1306 may include a display panel 13061, and the display panel 13061 may be configured in a form of a liquid crystal display, an organic light-emitting diode, or the like. The user input unit 1307 includes at least one of a touch panel 13071 and another input device 13072. The touch panel 13071 is also referred to as a touchscreen. The touch panel 13071 may include two parts: a touch detection apparatus and a touch controller. The another input device 13072 may include but is not limited to a physical keyboard, a function key (such as a volume control key or an on/off key), a trackball, a mouse, and a joystick. Details are not described herein.

In this embodiment of this application, after receiving downlink data from a network side device, the radio frequency unit 1301 may transmit the downlink data to the processor 1310 for processing. In addition, the radio frequency unit 1301 may send uplink data to the network side device. Generally, the radio frequency unit 1301 includes but is not limited to an antenna, an amplifier, a transceiver, a coupler, a low-noise amplifier, a duplexer, and the like.

The memory 1309 may be configured to store a software program or instructions and various types of data. The memory 1309 may mainly include a first storage area for storing a program or instructions and a second storage area for storing data. The first storage area may store an operating system, an application program or instructions required by at least one function (such as a sound playing function or an image playing function), and the like. In addition, the memory 1309 may include a volatile memory or a nonvolatile memory, or the memory 1309 may include both a volatile memory and a nonvolatile memory. The nonvolatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a Random Access Memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DR RAM). The memory 1309 in this embodiment of this application includes but is not limited to these memories and any other memory of an appropriate type.

The processor 1310 may include one or more processing units. Optionally, the processor 1310 integrates an application processor and a modem processor. The application processor mainly processes operations related to an operating system, a user interface, an application program, and the like. The modem processor, such as a baseband processor, mainly processes a wireless communication signal. It may be understood that the modem processor may not be integrated into the processor 1310.

The radio frequency unit 1301 is configured to receive a first positioning message, where the first positioning message is used for SL positioning; and/or the processor 1310 is configured to generate the first positioning message, and the radio frequency unit 1301 is configured to send the first positioning message.

In this embodiment of this application, to support a network side device serving as a positioning server in controlling a terminal to perform SL positioning, a protocol layer (that is, a first protocol layer) used to provide an SL positioning function is introduced into an air interface protocol stack architecture in a related technology. During SL positioning, the terminal may generate, at the newly introduced protocol layer, a first positioning message used for SL positioning, and may send the first positioning message; or the protocol layer of the terminal may receive the first positioning message to perform an SL positioning operation. In this way, the network side device serving as the positioning server can transmit an SL positioning message over an air interface, to control the terminal to perform SL positioning. In addition, an original protocol stack can be further reused to the maximum extent in this embodiment of this application, to support the SL positioning function while ensuring that an air interface positioning function is not affected.

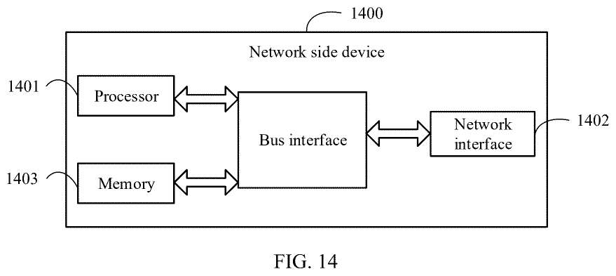

Specifically, an embodiment of this application further provides a network side device. As shown in FIG. 14, the network side device 1400 includes a processor 1401, a network interface 1402, and a memory 1403. The network interface 1402 is, for example, a Common Public Radio Interface (CPRI).

Specifically, the network side device 1400 in this embodiment of the present invention further includes instructions or a program that is stored in the memory 1403 and that is capable of running on the processor 1401. The processor 1401 invokes the instructions or the program in the memory 1403 to perform the methods performed by the modules shown in FIG. 4 and FIG. 5, and same technical effects are achieved. To avoid repetition, details are not described herein again.

An embodiment of this application further provides a readable storage medium. The readable storage medium stores a program or instructions. The program or the instructions are executed by a processor to implement processes in the foregoing embodiments of the positioning message transmission method, and same technical effects can be achieved. To avoid repetition, details are not described herein again.

The processor is a processor in the terminal in the foregoing embodiment. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement processes in the foregoing embodiments of the positioning message transmission method, and same technical effects can be achieved. To avoid repetition, details are not described herein again.

It should be understood that the chip mentioned in this embodiment of this application may also be referred to as a system-level chip, a system chip, a chip system, a system-on-a-chip, or the like.

An embodiment of this application further provides a computer program/program product. The computer program/program product is stored in a storage medium. The computer program/program product is executed by at least one processor to implement processes in the foregoing embodiments of the positioning message transmission method, and same technical effects can be achieved. To avoid repetition, details are not described herein again.

An embodiment of this application further provides a positioning message transmission system, including a terminal and a network side device. The terminal may be configured to perform the steps of the positioning message transmission method described in FIG. 4 or FIG. 5, and the network side device may be configured to perform the steps of the positioning message transmission method described in FIG. 2 or FIG. 3.

It should be noted that in this specification, terms “include”, “comprise”, or any other variant thereof is intended to cover non-exclusive inclusion, so that a process, method, article, or apparatus that includes a series of elements not only includes those elements, but also includes other elements that are not explicitly listed, or includes elements inherent to the process, method, article, or apparatus. Without more constraints, an element limited by the statement “includes a . . . ” does not exclude the existence of additional identical elements in the process, method, article, or apparatus that includes the element. In addition, it should be noted that, the scope of the method and apparatus in the implementations of this application does not limit performing functions in an order shown or discussed, and may further include performing functions basically simultaneously or in a reverse order based on the functions involved. For example, the described method may be performed in an order different from that described, and various steps may be added, omitted, or combined. In addition, features described with reference to some examples may be combined in other examples.

According to the descriptions of the foregoing implementations, a person skilled in the art may clearly understand that, the methods in the foregoing embodiments may be implemented by using software plus a necessary general hardware platform, or certainly may be implemented by using hardware. However, in many cases, the former is a better implementation. Based on such an understanding, the technical solutions in this application essentially or the part contributing to the related technologies may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings. However, this application is not limited to the foregoing specific implementations. The foregoing specific implementations are merely example but are not for limitation. Under the inspiration of this application, a person of ordinary skill in the art may make many forms without departing from the essence of this application and the scope of the claims, all of which fall within the protection of this application.

1. A positioning message transmission method, comprising at least one of the following:
generating, by a first protocol layer of a network side device, a first positioning message, wherein the first positioning message is used for sidelink (SL) positioning; and sending, by the first protocol layer of the network side device, the first positioning message; or
receiving, by the first protocol layer of the network side device, the first positioning message.

2. The method according to claim 1, wherein the sending, by the first protocol layer of the network side device, the first positioning message comprises sending, by the first protocol layer of the network side device, the first positioning message to a network side Access and Mobility Management Function (AMF) network element.

3. The method according to claim 1, wherein the receiving, by the first protocol layer of the network side device, the first positioning message comprises receiving, by the first protocol layer of the network side device, the first positioning message from an AMF.

4. The method according to claim 1, wherein after the receiving, by the first protocol layer of the network side device, the first positioning message, the method further comprises performing, by the network side device, an SL positioning operation based on the first positioning message.

5. A positioning message transmission method, comprising at least one of the following:
receiving, by a first protocol layer of a terminal, a first positioning message, wherein the first positioning message is used for sidelink (SL) positioning; or
generating, by the first protocol layer of the terminal, the first positioning message; and sending, by the first protocol layer of the terminal, the first positioning message.

6. The method according to claim 5, wherein receiving, by the first protocol layer of the terminal, the first positioning message comprises:
receiving, by the first protocol layer of the terminal, the first positioning message from a Non-Access Stratum (NAS) layer of the terminal, wherein the first protocol layer of the terminal is adjacent to the NAS layer of the terminal and is located at an upper layer of the NAS layer of the terminal.

7. The method according to claim 6, wherein before receiving, by the first protocol layer of the terminal, the first positioning message from the NAS layer of the terminal, the method further comprises:
receiving, by a Radio Resource Control (RRC) layer of the terminal, an RRC message from an RRC layer of a peer access network device, wherein the RRC message comprises a NAS message, and the NAS message comprises the first positioning message;
delivering, by the RRC layer of the terminal, the NAS message carried in the RRC message to the NAS layer of the terminal; and
receiving, by the NAS layer of the terminal, the NAS message, and delivering the first positioning message carried in the NAS message to the first protocol layer of the terminal.

8. The method according to claim 5, wherein after receiving, by the first protocol layer of the terminal, the first positioning message, the method further comprises performing, by the terminal, an SL positioning operation based on the first positioning message.

9. The method according to claim 5, wherein the sending, by the first protocol layer of the terminal, the first positioning message comprises delivering, by the first protocol layer of the terminal, the first positioning message to a NAS layer of the terminal, wherein the first protocol layer of the terminal is adjacent to the NAS layer of the terminal and is located at an upper layer of the NAS layer of the terminal.

10. The method according to claim 9, wherein after delivering, by the first protocol layer of the terminal, the first positioning message to the NAS layer of the terminal, the method further comprises:
delivering, by the NAS layer of the terminal, a NAS message to an RRC layer of the terminal, wherein the NAS message comprises the first positioning message; and
sending, by the RRC layer of the terminal, an RRC message to an RRC layer of a peer access network device, wherein the RRC message comprises the NAS message.

11. A terminal, comprising at least one hardware processor and a memory, wherein the memory stores a program or instructions, and when the program or the instructions are executed by the processor, the terminal is directed to perform at least one of the following:
receiving, by a first protocol layer of the terminal, a first positioning message, wherein the first positioning message is used for sidelink (SL) positioning; or
generating, by the first protocol layer of the terminal, the first positioning message; and sending, by the first protocol layer of the terminal, the first positioning message.

12. The terminal according to claim 11, wherein when the program or the instructions are executed by the processor, the terminal is directed to:
receive, by the first protocol layer of the terminal, the first positioning message from a Non-Access Stratum (NAS) layer of the terminal, wherein the first protocol layer of the terminal is adjacent to the NAS layer of the terminal and is located at an upper layer of the NAS layer of the terminal.

13. The terminal according to claim 12, wherein when the program or the instructions are executed by the processor, the terminal is further directed to:
before the first positioning message from the NAS layer of the terminal is received by the first protocol layer of the terminal, receive, by a Radio Resource Control (RRC) layer of the terminal, an RRC message from an RRC layer of a peer access network device, wherein the RRC message comprises a NAS message, and the NAS message comprises the first positioning message;
deliver, by the RRC layer of the terminal, the NAS message carried in the RRC message to the NAS layer of the terminal; and
receive, by the NAS layer of the terminal, the NAS message, and deliver the first positioning message carried in the NAS message to the first protocol layer of the terminal.

14. The terminal according to claim 11, wherein when the program or the instructions are executed by the processor, the terminal is further directed to after the first positioning message is received by the first protocol layer of the terminal, perform an SL positioning operation based on the first positioning message.

15. The terminal according to claim 11, wherein when the program or the instructions are executed by the processor, the terminal is directed to deliver, by the first protocol layer of the terminal, the first positioning message to a NAS layer of the terminal, wherein the first protocol layer of the terminal is adjacent to the NAS layer of the terminal and is located at an upper layer of the NAS layer of the terminal.

16. The terminal according to claim 15, wherein when the program or the instructions are executed by the processor, the terminal is further directed to:
after the first positioning message is delivered to the NAS layer of the terminal by the first protocol layer of the terminal, deliver, by the NAS layer of the terminal, a NAS message to an RRC layer of the terminal, wherein the NAS message comprises the first positioning message; and
send, by the RRC layer of the terminal, an RRC message to an RRC layer of a peer access network device, wherein the RRC message comprises the NAS message.

17. A network side device comprising at least one hardware processor and a memory, wherein the memory stores a program or instructions, and when the program or the instructions are executed by the processor, the network side device is directed to perform the method according to claim 1.

18. A non-transitory readable storage medium, wherein the readable storage medium stores a program or instructions, and when the program or the instructions are executed by at least one hardware processor, the method according to claim 1 is implemented.

19. A non-transitory readable storage medium, wherein the readable storage medium stores a program or instructions, and when the program or the instructions are executed by at least one hardware processor, the method according to claim 5 is implemented.
